(19) United States
(12) Patent Application Publication
(10) Pub. No.: US 2009/0191019 A1
(43) Pub. Date: Jul. 30, 2009

(54) FASTENER SAFETY RETENTION

(75) Inventor: Jerry Carl Billings, Yorba Linda, CA (US)

Correspondence Address: DISNEY ENTERPRISES, INC.;c/o Marsh Fischmann & Breyfogle LLP, 8055 East Tufts Avenue, Suite 450, Denver, CO, 80237, US

(73) Assignee: DISNEY ENTERPRISES, INC., Burbank, CA (US)

(21) Appl. No.: 12/021,475

(22) Filed: Jan. 29, 2008

(51) Int. Cl. F16B 41/00; B23P 11/00

(52) U.S. Cl. 411/5; 29/521

(57) ABSTRACT

A safety fastener capable of retaining portions thereof in the event of breakage is disclosed. The safety fastener includes a through hole along the longitudinal axis of a shaft. A secondary member, such as a wire rope, may be disposed within the through hole. Capturing members, such as balls sized larger than the through holes may be swaged or crimped to both ends of the secondary member, thereby capturing the shaft between them. In the event of breakage, portions of the shaft may remain substantially in place being confined by the secondary member and capturing members. Inspection of the safety fastener may include determining that the secondary member is loose relative to the shaft, thereby indicating that no gaps or separation has occurred in the shaft.

### BACKGROUND OF THE INVENTION

1. Field of the Invention

The present invention relates, in general, to hardware, and, more particularly, to fasteners that have supplemental members operable to indicate the status of the fastener and/or retain portions of the fastener upon breakage of the fastener.

2. Relevant Background

It has often been desirable to position clips or brackets in relation to fasteners in such a way as to retain portions of the fastener in the event the fastener breaks into two or more separate pieces. Such fastener retention systems are generally used where uncontrolled movement of a broken portion of a fastener may lead to injury or property damage. For example, certain bolts used in the aircraft industry may have a clip or bracket positioned over the head of the bolt to prevent the head of the bolt from becoming unrestrained in the event the bolt breaks.

Such fastener systems may be utilized for a variety of reasons. As noted above, the aircraft industry may use such systems to prevent portions of fasteners breaking loose and entering turbines or falling to the ground below. Such fastener systems may be used to secure fasteners used in high-speed equipment, where an unrestrained portion of a broken fastener could be thrown from the equipment at high speed. Such fastener systems may be used in amusement park attractions where equipment and people may be at significant heights and/or moving at high rates of speed where an unrestrained portion of a broken fastener could result in injury to patrons or workers in the vicinity of the attraction.

The above-described known fastener retention systems have several limitations. One limitation is that such systems require additional parts beyond that of the primary fastener in order to secure the portions of the primary fastener in the event of breakage of the primary fastener. Furthermore, the parts may require additional labor to install beyond the labor needed to install the primary fastener. Moreover, areas surrounding the fastener may require features, such as tapped holes, to enable securement of the additional parts so that they may perform the fastener retention function. In addition, the additional parts may interfere with visual and/or other inspection of the primary fastener.

It has also often been desirable to provide fastening systems that may be quickly inspected to verify their operating condition. For example, safety wire may be attached to a bolt head (e.g., running the safety wire through the head of the bolt through a hole perpendicular to a longitudinal axis of the bolt) to both secure the rotational position of the bolt and to provide a visual indication of the status of the bolt for inspection. The safety wire may be attached to a member external to the bolt. Such a system requires additional parts to be assembled at the location of the installation of the bolt. Attaching safety wire to a bolt is also a labor-intensive task. Furthermore, the safety wire may need to be removed in order to remove the bolt, requiring additional labor. For another example, a bolt head and a corresponding proximate surface may be correspondingly marked with alignment marks and/or a putty-like substance (e.g., torque stripe or paint) so that any movement of the bolt head relative to the proximate surface may be detected. Although such marking may be quickly evaluated, such marking may provide no retention capabilities in the event of bolt failure and may not provide information regarding the status of the bolt below the head.

### SUMMARY OF THE INVENTION

Embodiments of the present invention address the above-described issues by providing hardware that includes a secondary member capable of retaining portions of the hardware in the event of breakage of the hardware. The hardware may achieve such performance without the need for additional components that must be installed separately at the location where the hardware is employed. Furthermore, such hardware may be easily inspected to verify its operating condition.

The hardware may be in the form of a fastener, such as, for example, a bolt or a pin. The secondary member may be free from direct securement to a shaft of the fastener. In this regard, the secondary member may be capable of remaining in tact in the event that the shaft of the fastener fails. The secondary member may then function to retain the broken portions of the shaft of the fastener until the breakage can be detected and repaired.

In this manner, an easily installed and inspected fastener is provided that provides safety retention capabilities. Such fasteners may be stocked and installed in the same manner as non-safety fasteners, yet provide retention capabilities in case of breakage.

In one aspect, a fastener comprises a shaft with a through hole and a secondary member. The shaft may have a first end and a second end and the secondary member may include a first portion extending beyond the first end of the shaft, a second portion extending beyond the second end of the shaft and a third portion disposed within the through hole.

In an embodiment, a first capturing member may be connected to the first portion of the secondary member and a second capturing member may be connected to the second portion of the secondary member. The first and second capturing members may each have a cross dimension in a plane perpendicular to a central axis of the through hole that is greater than a diameter of the through hole.

In an arrangement, the secondary member may be free from direct securement to the shaft. In an arrangement, the shaft may include a head disposed at one of the ends of the shaft. The shaft may include a notch near one or both of the ends of the shaft. The notch or notches may be configured to work with corresponding clips or other appropriate hardware to secure the fastener in place.

In an embodiment, the shaft may have a longitudinal axis and the through hole may be through the entire length of the shaft along the longitudinal axis. The third portion of the secondary member may be disposed within the through hole along the entire length of the shaft.

The secondary member may be flexible. The secondary member may, for example, comprise wire, rope, wire rope, cable, cord, strap, and/or line. In a particular arrangement, the secondary member may comprise metal wire rope. There may be clearance between the inside of the through hole and the secondary member. In this regard, a maximum cross dimension of the secondary member may be less than a minimum diameter of the through hole.

The first and second capturing members may be swaged onto the secondary member or attached thereto in any appropriate manner. In another arrangement, one or both of the capturing members may be at least partially formed from the secondary member. The distance between the first and second capturing members may be greater than the length of the shaft.

In another aspect, a fastener is provided that comprises: a shaft with a longitudinal axis; a through hole through the entire length of the shaft along the longitudinal axis; and a secondary member. The secondary member may be disposed within the through hole and may be free from securement to the shaft. The shaft may have a first end and a second end.

In an embodiment of the current aspect, the fastener may include first and second capturing members each connected to the secondary member. A portion of the shaft may be disposed between the first and second capturing members. The capturing members may be sized such that they are incapable of passing through a portion of the through hole between the first and second capturing members. In this regard, the first and second capturing members may each have a cross dimension in a plane perpendicular to the longitudinal axis greater than a diameter of a portion of the through hole between the first and second capturing members.

In vet another aspect, a method of manufacturing a fastener is provided. The method may include providing a shaft having a longitudinal axis, inserting a secondary member into a through hole through the shaft, forming a first capturing member positioned along a first portion of the secondary member, and forming a second capturing member positioned along a second portion of the secondary member. The through hole through the shaft may be disposed through the entire length of the shaft along the longitudinal axis. The first portion of the secondary member may extend beyond a first end of the shaft and the second portion of the secondary member may extend beyond a second end of the shaft. A third portion of the secondary member may be disposed within the through hole along an entire length of the shaft.

In an embodiment, the step of forming the first capturing member may include attaching a first member to the first portion of the secondary member. The step of forming the second capturing member may include attaching a second member to the second portion of the secondary member. Attaching the first and second members may include swaging the members onto the secondary member. In an embodiment, at least one of the forming the first capturing, member and forming the second capturing member steps may comprise forming the respective capturing member from the secondary member.

In still another aspect a bolt is provided that may include a shaft with a through hole, an elongate flexible retention member and first and second capturing members. The shaft may have a longitudinal axis. The shaft may include first and second ends with a head disposed at the first end and an externally threaded portion disposed at the second end. The through hole may be through the entire length of the shaft along the longitudinal axis. The elongate flexible retention member may include a first portion extending beyond the first end of the shaft, a second portion extending beyond the second end of the shaft and a third portion disposed within the through hole along the entire length of the shaft. The elongate flexible retention member may be free from direct securement to the shaft. The elongate flexible retention member may be a wire rope. The first capturing member may be connected to the first portion of the elongate flexible retention member and the second capturing member may be connected to the second portion of the elongate flexible retention member. The first and second capturing members may each have a cross dimension in a plane perpendicular to the longitudinal axis greater than a diameter of the through hole. In this regard, the shaft may capture the secondary member between the first and second capturing members. A distance between the first and second capturing members may be greater than the length of the shaft.

Further areas of applicability of the present invention will become apparent from the detailed description provided hereinafter. The various features, arrangements and embodiments discussed above in relation to each aforementioned aspect may be utilized by any of the aforementioned aspects.

### BRIEF DESCRIPTION OF THE DRAWINGS

FIG. 1 is a partial cross sectional view of an embodiment of a fastener that includes a secondary member.

FIG. 2 is an end view of the fastener of FIG. 1.

FIG. 3 is a partial cross sectional view of an embodiment of a fastener in the form of a pin.

FIG. 4 is a partial cross sectional view of the fastener of FIG. 1 after it has experienced a partial failure.

FIG. 5 is a partial cross sectional view of the fastener of FIG. 1 after it has experienced a partial failure.

### DETAILED DESCRIPTION OF THE PREFERRED EMBODIMENTS

Briefly, embodiments of the present invention are directed to fasteners, hardware and related methods. Particularly, embodiments described herein provide for fasteners that include secondary members that may aid in inspection procedures and fastener part retention in the event of breakage. For example, fasteners and methods disclosed herein may be operable to retain portions of the fastener upon breakage, thereby preventing potential further damage to equipment or injury to persons due to uncontrolled fastener portions.

For example, such a fastener may be used in critical applications where relatively frequent inspection is used to verify the integrity of the fastener. Such applications may include, inter alia, aircraft and other transportation systems, industrial machinery, construction and excavation equipment, and amusement park rides. These and other applications may require frequent inspection (e.g., daily) to ensure the safety and proper operation of equipment.

For example, such a fastener may be used in critical applications where uncontrolled fragments from broken fasteners may lead to further damage or injury. In the example of a bolt, the failure is often near the head, such that the head of the bolt may break away from the remainder of the fastener. In aircraft for example, portions of broken fasteners could fall into critical equipment, such as the turbine blades of a jet engine, potentially causing catastrophic damage. Also, portions of broken fasteners falling from significant heights could cause injury or damage to property. In another example, portions of the amusement park attractions may be traveling at significant speeds and/or occupying significant heights with numerous patrons and workers in proximity. In such an example, it may be highly desirable to retain portions of broken fasteners (e.g., retain a broken head so that it remains with the shaft of the fastener) to prevent injury.

The fasteners described herein have several advantages over existing fastener retention systems. For example, many existing fastener retention systems comprise several individual parts that must be assembled after the primary fastener is installed. Such systems may require brackets to be attached onto assemblies where the brackets function to restrain portions of the fastener in case of fastener breakage. Such brackets may require additional fasteners, washers, and/or other parts after the primary fastener has been installed. Such systems may require additional labor to install the additional parts after installation of the primary fastener. Such systems may partially or fully obscure the underlying fastener, thus hampering and/or preventing inspection. Such systems may not be operable to retain portions of broken fasteners where the portions are particularly small (e.g., where a head portion of a fastener separates from the remaining portion of the fastener).

In contrast, and as discussed in detail below, embodiments of the fasteners described herein may be installed without the need for the installation of additional parts such as brackets, clips, or other retention devices. Accordingly, installation and removal times for the embodiments of fasteners described herein may be less than known fastener retention systems. Furthermore, embodiments of fasteners described herein may be inspected without the need to remove other parts. Furthermore, embodiments of fasteners described herein may be stocked as a single part and thus not require the additional stocking and handling of additional parts such as brackets, clips, or other retention devices.

Although generally discussed herein in terms of a bolt with safety retention capabilities, features and aspects described herein may be applied to other fastener and hardware types. For example, fasteners such as pins, screws, axles rods, and/or other hardware (e.g., any elongate member that may be straight or curved) may utilize the secondary members and capturing members described herein.

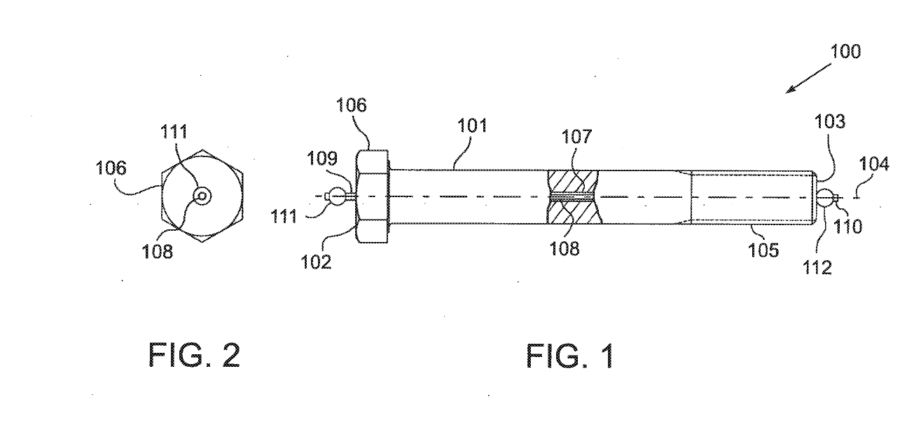

FIG. 1 is a partial cross sectional plan view of an embodiment of a fastener 100. The fastener 100 of FIG. 1 is in the form of a bolt. FIG. 2 is an end view of the bolt of FIG. 1. Returning to FIG. 1, the fastener 100 includes a shaft 101 that has a first end 102 and a second end 103. The shaft 101 is oriented along a longitudinal axis 104 that passes through the center of the shaft 101. The shaft 101 may include a threaded area 105 at the second end 103 of the shaft 101. The shaft 101 may also include a head 106 disposed at the first end 102. The shaft 101 may be generally cylindrical in the area of the shaft 101 between the head 106 and the second end 103.

The shaft 101 may be constructed from any appropriate material generally used in fasteners. For example, the shaft 101 may be constructed from steel. The shaft 101 may be manufactured to a particular standard such as, for example, an SAE grade, an ASTM standard, and/or a, DIN standard. The diameter and length of the shaft 101 may be sized to match a particular application, which may depend on, for example, strength and space requirements.

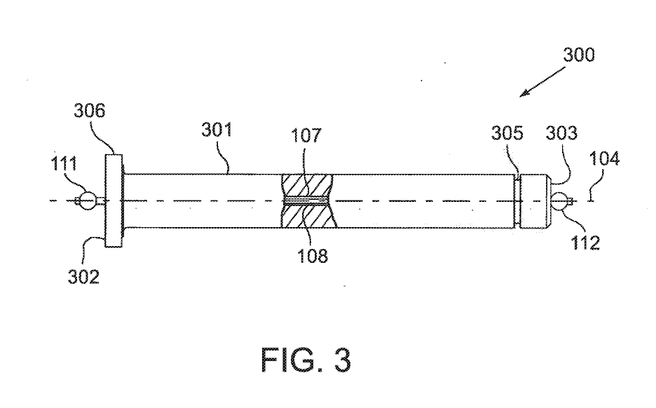

Although the shaft 101 of FIG. 1 is in the form of a bolt, other types of fasteners may incorporate features and aspects described herein. For example, and as shown in FIG. 3 described below, features and aspects of the present invention may be incorporated into a pin such as fastener 300. Furthermore features and aspects of the present invention may be incorporated into other types of fasteners and hardware.

The threaded area 105 may include any appropriate thread configuration. For example, the threads may be fine pitch or coarse pitch threads as known to those skilled in the art. Other types of threads may also be used. The threaded area 105 may mate with a nut, such as a hex nut, wing nut, locking nut, or any other appropriate type of nut. The threaded area 105 may mate with a threaded hole. The threaded hole may be a through hole or a blind hole. In a particular application, the fastener 100 may be installed with any appropriate additional hardware such as, for example, flat washers and/or lock washers.

The head 106 of the shaft 101 may, be any appropriate shape. For example, and as illustrated in FIGS. 1 and 2, the head 106 may be hexagonally shaped for engagement with an appropriate tool (e.g. wrench, socket). The head 106 may be configured using other appropriate shapes (e.g., square). The head 106 may perform those functions typically associated with the head of a fastener, such as enabling the fastener to be driven by a mating tool and providing a surface on the underside of the head capable of exerting a force on members to be fastened by the fastener.

The fastener 100 includes a through hole 107 disposed along the longitudinal axis 104 of the shaft 101 and extending the full length of the shaft 101. The through hole 107 may be round in cross section. The through hole 107 may be along the longitudinal axis 104 as illustrated or it may be offset from the longitudinal axis 104. Other hole configurations may be used, such as square or octagonal. The through hole 107 illustrated in FIG. 1 is of a single diameter along the entire length of the shaft 101. Other hole configurations, for example with counter bores or countersinks at one or both ends of the shaft 101, may be utilized.

The fastener 100 of FIG. 1 further includes a secondary member 108. The secondary member 108 may be disposed within a portion of the through hole 107. As illustrated in FIG. 1, the secondary member 108 may be disposed within the entire through hole 107 and extend beyond the first end 102 and the second end 103 of the shaft 101. The secondary member 108 may be free from direct securement to the shaft 101. In this regard, the secondary member 108 may be free to move within the through hole 107 relative to the shaft 101. Where the secondary member 108 and the through hole 107 are both round, the outside diameter of the secondary member 108 may be smaller than the diameter of the through hole 107.

The secondary member 108 may be constructed from any appropriate material. The secondary member 108 may be a flexible member or it may be non-flexible. The secondary member 108 may be constructed from a single rod of material. Alternatively, the secondary member 108 may comprise a material comprising a plurality of individual portions, such as a wire rope. Indeed, any appropriate material, such as wire, rope, cable, cord, strap, and line may be used in the construction of the secondary member 108.

As noted above, the through hole 107 may include counterbores or countersinks at either end of the shaft 101. In such a configuration, the secondary member 108 may be of a length that exceeds the length of the portion of the through hole 107 between the counterbores and/or countersinks. In an embodiment where the secondary member 108 is longer than the shaft 101, the secondary member 108 may include a first portion of the secondary member 109 that extends beyond the first end 102 of the shaft 101 and a second portion of the secondary member 110 that extends beyond the second end 103 of the shaft 101. In such an embodiment, the secondary member 108 may include a third portion between the first and second portions of the secondary member 109, 110.

The fastener 100 may include a first capturing member 111 and a second capturing member 112. As shown in FIG. 1, the first and second capturing members 111, 112 may be in the form of balls or other appropriately shaped members swaged onto (or attached in any other appropriate manner) and fixedly secured to the secondary member 108. The capturing members 111, 112 may be sized so that they are incapable of passing through the minimum cross-sectional size portion of the through hole 107. For example, the capturing members 111, 112 when in the form of a ball swaged onto the secondary member 180, may have a diameter that is larger than the minimum diameter of the through hole 107.

Accordingly, when fixedly secured to the secondary member 108, the first and second capturing members 111, 112 may prevent the secondary member 108 from moving out of the through hole 107. Although illustrated and described as balls swaged to the secondary member 108, the capturing members 111, 112 may be of any appropriate configuration capable of fixedly attaching to the secondary member 108 while not being capable of passing through the through hole 107.

In an embodiment, the first and/or the second capturing member 111, 112 may be formed from the secondary member 108 itself. For example, where the secondary member 108 is a wire rope, a portion of the secondary member 180 may be tied into a knot to form one of the capturing members 111, 112. For another example, the secondary member 108 may be swaged, crimped, bent and/or otherwise deformed to form one of the capturing members 111, 112 into a structure that is incapable of passing through the through hole 107. In another example, the secondary member 108 may be formed by soldering or welding the secondary member 108 such that a bulbous portion forms the first and/or second capturing member 111, 112.

The first and second capturing members 111, 112 may be positioned to allow room for a tool to attach/create the first and second capturing members 111, 112. This is discussed further below in relation to a method of manufacturing the fastener 100.

FIG. 3 illustrates an alternate embodiment of a fastener 300. The fastener 300 of FIG. 3 is in the form of a pin. Many features of the fastener 300 are similar to those of the fastener 100 of FIG. 1 and therefore will not the repeated. The fastener 300 includes a shaft 301 with a first end 302 in the second end 303. A head 306 may be positioned at the first end 302 of the shaft 301. Since the fastener 300 is in the form of a pin, the head 306 need not be of a drivable configuration. Accordingly, the head 306 may be round as shown in FIG. 3 or the head 306 may be of any other appropriate shape.

The shaft 301 may be cylindrical and include a retention feature 305. The retention feature 305 may be a notch that encompasses the entire circumference of the shaft 301. The retention feature 305 in the form of a notch may provide an area where a clip (e.g., c-clip) may be interconnected to the shaft 301 after the fastener 300 has been inserted into an assembly, thereby capturing the assembly between the clip inserted into the retention feature 305 and the head 306. As in the fastener 100 described above, the fastener 300 may include the longitudinal axis 104, through hole 107, secondary member 108, first capturing member 111, and second capturing member 112, all of which may be similarly configured as described above with reference to the fastener 100.

Although illustrated as cylindrical, the shaft 301 may be configured in any appropriate shape. For example, the shaft 301 may be square. Although as illustrated as a circumferential notch, the retention feature 305 may take the form of any appropriate the feature operable to provide a location to install a member to limit the movement of the fastener 300 once is it is installed. For example, the retention feature 305 may be in the form of a straight notch disposed across a portion of the diameter of the shaft 301 where a corresponding member inserted into the sttaight notch may limit axial movement of the fastener 300. Also, in place of the head 306 may be another notch such as notch 305. Additionally, the fastener 300 may be designed for press fit applications in which case one or both ends may be without a notch and/or a head.

Such a fastener 300 may be used to secure parts together along the direction of the longitudinal axis 104 while allowing the secured parts to pivot or rotate relative to each other. In another example, the fastener 300 may be used to secure a wheel or pulley to another member in a manner that allows the wheel or pully to rotate relative to the other member.

A method of the fabrication of the fastener 100 of FIG. 1 will now be described. The first step in the process may be to manufacture a bolt in the desired configuration according to known manufacturing methods. For example, a bolt similar to the fastener 100 of FIG. 1, but without the through hole 107, may be made by casting and/or machining a bolt from, for example, steel. The through hole 107 may then be formed within the shaft 101 by drilling one or both ends of the shaft 101. Alternatively, the through hole 107 may be formed at the same time that the bolt is formed (e.g., through hole 107 may be formed at the time of the original casting of the shaft 101).

The next step in the process of fabricating the fastener 100 may be to insert the secondary member 108 into the through hole 107 at the first end 102 of the shaft 101 until a portion of the secondary member 108 extends beyond the second end 103. This may be followed by attaching/forming the second capturing member 112 to the second portion of the secondary member 110 that is extending beyond second end 103. This attaching/forming step may be performed with the second capturing member 112 attachment point to the secondary member 108 positioned at any convenient distance away from the second end 103. In this regard, after the second capturing member 112 is secured, the secondary member 108 may be pulled in the direction of the first end 102 to bring the second capturing member 112 into contact with the second end 103 of the shaft 101 as illustrated in FIG. 1.

The next step may be to attach the first capturing member 111 to the first portion of the secondary member 109 that extends beyond the first end 102 of the shaft 101. It may be desirable to pull the second capturing member 112 up against the second end 103 so that the first capturing member 111 may be interconnected to the secondary member 108 as close as possible to the second capturing member 112 thus minimizing the length of the secondary member 108 between the first capturing member 111 and the second capturing member 112. However, a distance between the first capturing member 111 and the first end 102 of the shaft 101, such as the distance illustrated in FIG. 1, may be required to allow clearance for a tool (e.g., a swaging tool) to install the first capturing member 111 onto the secondary member 108. It will be appreciated that some clearance between the first capturing member 111 and the first end 102 (e.g., the length of the secondary member 108 between the first and second capturing members 111, 112 is longer than the shaft 101) may be desirable for functional and inspection related functions as described below.

Although described above as being assembled in a particular order, the order of which end of the shaft 101 the secondary member 108 is inserted into first and which secondary member 111, 112 is interconnected first may be altered. Although the above description of the manufacturing method was described in terms of the fastener 100 of FIG. 1, it will be appreciated that similar techniques may be used to manufacture other types of fasteners disclosed herein (e.g., the pin of FIG. 3).

The embodiments of fasteners described herein may be assembled as described above and then stored for later use in a manner similar to other fasteners. This is in contrast to some known fastener retention systems which require the storing of the bolt itself, storing clips or brackets used to retain the bolts once they are in an installed position, and storing any hardware, such as screws or washers, that may be needed to secure the clips or brackets such that they are operable to retain the bolts. Furthermore, some known fastener retention systems required additional machining in the area of the bolt to be retained. This may be in the form of additional tapped holes or through holes to which the retention hardware may be fastened. In contrast, the embodiments of fasteners described herein may not require any additional machining or configuration to areas around the fastener.

The embodiments of fasteners described herein may include the safety retention features described herein, yet require no additional labor to install such as required by many known fastener retention systems. For example, some known fastener retention systems may require the additional installation of clips or brackets and fasteners to attach those clips or brackets that may be required after the original installation of the primary fastener. In contrast, embodiments of fasteners described herein do not require the labor to attach additional components after the initial installation. Indeed, embodiments of fasteners described herein may not require any additional labor beyond that needed to install any standard fastener (e.g., a typical bolt). Furthermore, embodiments of the fasteners described herein may be operable to be installed using standard, commonly available tools, such as wrenches (e.g., open-end and/or box wrenches), and sockets. Embodiments of the fasteners described herein may be used in most applications where standard fasteners are currently used. For example, embodiments of fasteners described herein may be used with standard nuts, wing nuts, locking nuts, through holes, and blind holes.

As described, embodiments of fasteners disclosed herein include a through hole 107 extending through the shaft 101 along the longitudinal axis 104. Such a through hole 107 may be relatively small in diameter relative to the diameter or cross-sectional size of the shaft 101. In this regard, the through hole 107 may have a relatively small impact on the overall strength of the fastener 100. For example, in an embodiment, the ratio of the minimum outer cross-sectional dimension of the shaft 101 to the diameter of the through hole 107 may be at least 6 to 1. If the relatively small impact of the through hole 107 on the overall strength of the fastener 100 is a concern in a particular application, the strength of the fastener 100 may be increased. This may be accomplished by, for example, increasing the overall size of the shaft 101 and/or choosing a higher strength material for the fastener 100.

In the event of a failure of the shaft 101, the secondary member 108 may prevent portions of the fastener 100 from separating fully from the assembly in which the fastener 100 is incorporated. For example, where breakage occurs in the shaft 101, individual separate portions of the shaft 101 will be retained by the secondary member 108 when the individual portions include a portion of the length of the through hole 107. In this regard, the first and second capturing members 111, 112 may retain the broken pieces of the shaft 101 between them and along the secondary member 108.

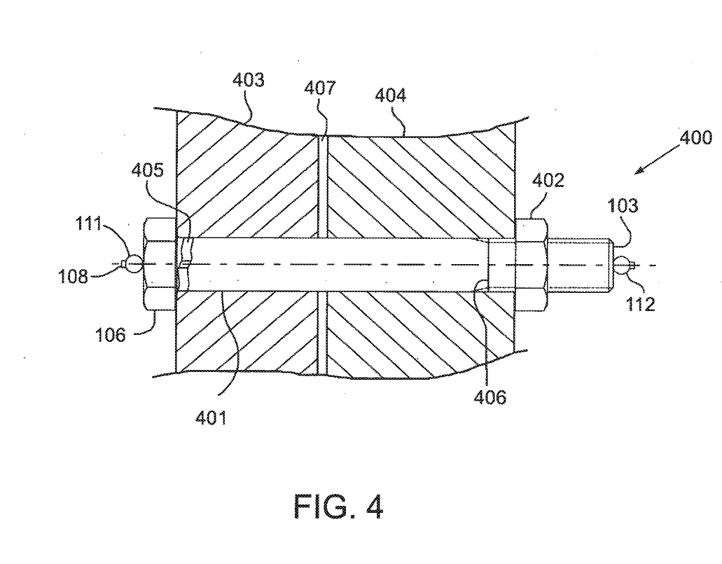

For example, a known mode of failure for a bolt is where the head separates from the shaft at the interface between the head and the shaft. Such a failure is illustrated in FIG. 4, which illustrates the fastener 100 of FIG. 1 after breakage. In the configuration shown in FIG. 4, the broken fastener 400 was installed with a nut 402 and positioned to hold together a first member 403 and a second member 404 (shown in cross section) such that the first member 403 and second member 404 were in direct contact with each other. FIG. 4 illustrates a separation between the first member 403 and the second member 404 after breakage of the fastener 400. The head 106 has separated from the remaining portion of a broken shaft 401 at a fracture point 405 at the interface between the head 106 and the rest of the shaft 401. In such a case, both the head 106 and the shaft 401 may remain disposed about the secondary member 108 and confined to the portion of the secondary member 108 between the first and second capturing members 111, 112. Accordingly, the head 106 will not be able to separate from the remaining portion of the faster 400, thus potentially preventing further damage or injury.

The secondary member 108 may be sufficiently flexible and/or compliant such that it is capable of withstanding forces that may result in and/or from breakage of the shaft 401. This may result in the secondary member 108 not failing even though the surrounding shaft 401 experiences breakage.

For example, the fastener 400 in tension may fail due to the tension or the tension coupled with other forces (e.g., from vibration, shock, etc). The failure may result in a separation of the broken parts by a small distance 407. This distance 407 may be less than or equal to the slack between the first and second capturing members 111, 112 and the shaft 401. Therefore, only a portion or none of the shock of breakage may be translated to the secondary member 108. As illustrated in FIG. 4, the secondary member 108 may remain in tact and operable to confine the broken pieces of the fastener 400. As previously noted such retention capabilities may be beneficial in certain applications (e.g., amusement park attractions, aircraft).

In addition to the retention of broken portions of the fastener 400, the secondary member 108 may also be operable to retain some capabilities with respect to the primary function of the fastener 400. For example, as illustrated in FIG. 4 where the fastener 400 is being used to hold two members 403, 404 together and the shaft 401 fails as described above, the ability of the secondary member 108 to retain the head 106 proximate to the shaft 401 and the strength of the secondary member 108 may allow the fastener 400 to continue to hold the two members 403, 404 in proximity to each other. Of course, in such a scenario, the two members 403, 404 may not be held together with the same compressive forces as when the fastener 400 was intact. However, the secondary member 108 may be operable to temporarily hold the two members 403, 404 together until subsequent discovery of the failure and repair.

After a failure, such as the failure described above where the head 106 separates from the remaining portion of the shaft 401, a visual inspection may readily reveal the breakage if the head is loosely held proximate to the shaft 401. However, if the members 403, 404 being held together separate (e.g. as illustrated in FIG. 4) such that the head 106 is disposed against one of the members 403, 404, or if the shaft 401 were to break along a portion of the shaft 401 that is not readily visible by inspection (e.g., in the transition 405 between the non-threaded portion of the shaft 401 and the threaded area 105). a visual inspection may not readily reveal the breakage. After such a breakage, the individual portions of the shaft 401 may separate and take up the slack in the secondary member 108 such that both the head 106 and the second end 103 of the shaft 401 are positioned against the first and second capturing members 111, 112 respectively. In such a case, a visual and/or tactile inspection of the fastener 400 may reveal that, as illustrated in FIG. 4, no slack exists in the secondary member 108, thereby indicating a potential failure of the fastener 400. In particular, an inspector may touch and/or attempt to move one of the exposed capturing members 111, 112. If such an inspection reveals no slack and/or looseness of the first and/or second capturing member 111, 112 relative to the shaft 401 the inspector may further inspect the fastener 400 (e.g., by removing the fastener 400 from its installation). If such an inspection reveals less than the expected amount of slack and,/or looseness this may indicate a potential failure and warrant further inspection. Conversely, where the inspection reveals the expected amount of slack and/or looseness of the secondary member 108 and first and/or second capturing members 111, 112, this may be an indication that no gap and/or breakage exists, as in the shaft 101 of FIG. 1. Such inspection techniques may represent a potential improvement over the prior art, where a clip or bracket covering the head of a bolt that may retain the head in the event of failure may also restrict access to the bolt and therefore require removal of the clip or bracket to inspect the underlying bolt.

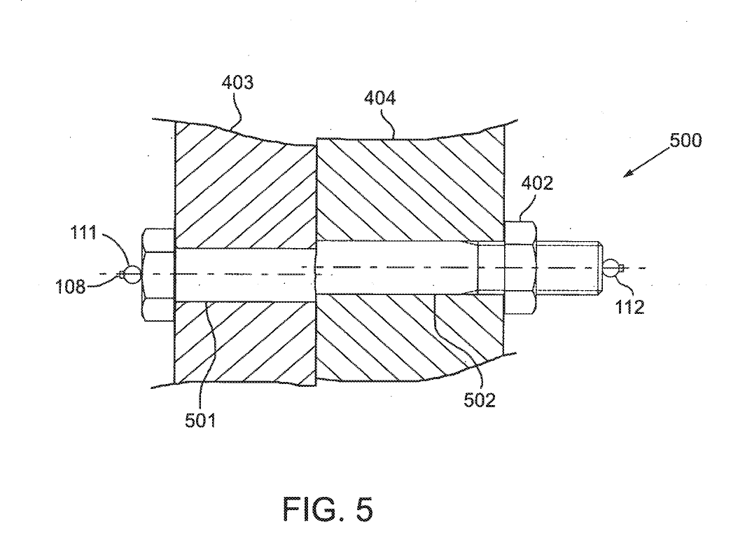

FIG. 5 illustrates the fastener 100 of FIG. 1 after a breakage of a different type than illustrated in FIG. 4. In the configuration shown in FIG. 5, the broken fastener 500 was installed with a nut 402 and positioned to hold together a first member 403 and a second member 404 (shown in cross section) such that the first member 403 and second member 404 were in direct contact with each other. FIG. 5 illustrates a relative lateral shift in position between the first member 403 and the second member 404 after breakage of the fastener 500. A first portion 501 of the fastener 500 has broken from a second portion 502 at the interface between the two members 403, 404. This may represent a failure mode where the fastener 500 failed at least in part due to shearing forces between the two members 403 and 404. In such a case both the first portion 501 and the second portion 502 may remain disposed about the secondary member 108 and confined to the portion of the secondary member 108 between the first and second capturing members 111, 112. Accordingly, neither the first portion 501 nor the second portion 502 may be able to separate from the assembly, thus potentially preventing further damage or injury.

After a failure such as illustrated in FIG. 5, a visual inspection may not readily reveal the breakage. However, after such a breakage, the first and second portions of the shaft 501, 502 may separate and take up the slack in the secondary member 108 such that a tactile inspection of the fastener 500 may reveal that reduced slack or no slack exists in the secondary member 108, thereby indicating a potential failure of the fastener 400. Moreover, if the first and second portions 501, 502 have shifted relative to each other enough that the secondary member 108 is pinched at the interface between the first portion 501 and the second portion 502, the secondary member 108 may be incapable of moving relative to the fastener 500. Accordingly, a tactile inspection may reveal such a lack of mobility of the secondary member 108.

### EXAMPLE

In one particular embodiment of the present invention, the shaft comprises a ¾−10×6″ Grade 8 steel bolt with a 0.109 diameter through hole along the longitudinal axis of the bolt. The resulting ratio of the shalt size to the hole size is approximately 6.9 to 1. Within the through hole is disposed a stainless steel aircraft quality wire rope comprising seven strands, each comprising 19 wires. At both ends of the wire rope, a 0.288″ diameter stainless steel ball is fixedly attached (e.g., crimped, swaged) to the wire rope. The slack between the balls and the bolt (e.g., the difference between the length of bolt and the distance between the two balls along the wire rope) is between 0.09″ and 0.15″. In the present particular embodiment the slack may be required to accommodate clearances for the tool used to attach the balls to the wire rope. Furthermore, the wire rope may extend a maximum of 0.062″ beyond the balls. In the present particular embodiment this distance may be required to accommodate tooling used to cut the wire rope after the balls are fixedly attached to it.

Although the above-described fasteners and methods have generally been described in terms of a bolt, other types of fasteners and/or hardware may incorporate the features and methods taught herein. For example, screws, pins, and axles may incorporate secondary members and capturing members and thereby gain some or all of the above-described advantages such as, for example, ease of inspection and retention after breakage.

1. A fastener comprising:
a shaft, wherein said shaft includes a first end and a second end;
a through hole through said shaft; and
a secondary member, said secondary member including a first portion extending beyond said first end of said shaft, a second portion extending beyond said second end of said shaft and a third portion disposed within said through hole.

2. The fastener of claim 1 further comprising:
a first capturing member connected to said first portion of said secondary member; and
a second capturing member connected to said second portion of said secondary member, wherein said first and second capturing members each have a cross dimension in a plane perpendicular to a central axis of said through hole that is greater than a diameter of said through hole.

3. The fastener of claim 1, wherein said secondary member is free from direct securement to said shaft.

4. The fastener of claim 1, wherein said shaft includes a head disposed at said first end of said shaft.

5. The fastener of claim 1, wherein said shaft has a longitudinal axis, wherein said through hole is through an entire length of said shaft along said longitudinal axis, wherein said third portion is disposed within said through hole along said entire length of said shaft.

6. The fastener of claim 1, wherein a ratio of a minimum outer diameter of said shaft to a diameter of said through hole is at least 6 to 1.

7. The fastener of claim 1, wherein said secondary member is flexible.

8. The fastener of claim 2, wherein said first and second capturing members are swaged onto said secondary member.

9. The fastener of claim 8, wherein a distance between said first and second capturing members is greater than the length of said shaft.

10. The fastener of claim 7, further comprising:
a first capturing member positioned along said first portion of said secondary member; and
a second capturing member positioned along said second portion of said secondary member, wherein said first and second capturing members each have a cross dimension in a plane perpendicular to a central axis of said through hole that is greater than a diameter of said through hole, wherein at least one of said first and second capturing members are at least partially formed from said secondary member.

11. The fastener of claim 1, wherein said secondary member comprises at least one item selected from a group consisting of wire, rope, wire rope, cable, cord, strap, and line.

12. The fastener of claim 11, wherein said secondary member comprises metal wire rope.

13. The fastener of claim 6, wherein a maximum cross dimension of said secondary member is less than a minimum diameter of said through hole.

14. A fastener comprising:
a shaft, wherein said shaft includes a first end and a second end, wherein said shaft has a longitudinal axis;
a through hole through the entire length of said shaft along said longitudinal axis; and
a secondary member disposed within said through hole, wherein said secondary member is free from securement to said shaft.

15. The fastener of claim 14, further comprising:
a first capturing member connected to said secondary member; and
a second capturing member connected to said secondary member, wherein a portion of said shaft is disposed between said first and second capturing members, wherein said first and second capturing members each have a cross dimension in a plane perpendicular to said longitudinal axis greater than a diameter of said portion of said through hole between said first and second capturing members.

16. A method of manufacturing a fastener, said method comprising:
providing a shaft having a longitudinal axis, wherein said shaft includes a through hole through the entire length of said shaft along said longitudinal axis;
inserting a secondary member into said through hole, wherein after said inserting step a first portion of said secondary member extends beyond a first end of said shaft, a second portion of said secondary member extends beyond a second end of said shaft, and a third portion of said secondary member is disposed within said through hole along an entire length of said shaft;
forming a first capturing member positioned along said first portion of said secondary member; and
forming a second capturing member positioned along said second portion of said secondary member.

17. The method of claim 16, wherein said forming said first capturing member step comprises attaching a first member to said first portion of said secondary member, wherein said forming said second capturing member step comprises attaching a second member to said second portion of said secondary member.

18. The method of claim 17, wherein said attaching said first member comprises swaging said first member, wherein said attaching said second member comprises swaging said second member.

19. The method of claim 16, wherein at least one of said forming a first capturing member and forming a second capturing member steps comprises forming said at least one of said first capturing member and said second capturing member from said secondary member.

20. A bolt comprising:
a shaft, wherein said shaft includes a first end and a second end, wherein said shaft has a longitudinal axis, wherein said shaft includes a head disposed at said first end of said shaft, wherein said shaft includes an externally threaded portion;
a through hole through the entire length of said shaft along said longitudinal axis;
an elongate flexible retention member, said elongate flexible retention member including a first portion extending beyond said first end of said shaft, a second portion extending beyond said second end of said shaft and a third portion disposed within said through hole along an entire length of said shaft, wherein said elongate flexible retention member is free from direct securement to said shaft;
a first capturing member connected to said first portion of said elongate flexible retention member; and
a second capturing member connected to said second portion of said elongate flexible retention member, wherein said first and second capturing members each have a cross dimension in a plane perpendicular to said longitudinal axis greater than a diameter of said through hole, wherein a distance between said first and second capturing members is greater than the length of said shaft.
